(19) United States
(12) Patent Application Publication
(10) Pub. No.: US 2024/0387993 A1
(43) Pub. Date: Nov. 21, 2024

(54) ANTENNA DEVICE AND COMMUNICATION APPARATUS

(71) Applicant: Murata Manufacturing Co., Ltd., Nagaokakyo-shi (JP)

(72) Inventor: Toumu TANABE, Nagaokakyo-shi (JP)

(21) Appl. No.: 18/785,041

(22) Filed: Jul. 26, 2024

Related U.S. Application Data
(63) Continuation of application No. PCT/JP2023/008831, filed on Mar. 8, 2023.

(30) Foreign Application Priority Data
Mar. 16, 2022 (JP) 2022-041339

(51) Int. Cl. H01Q 5/35; H01Q 5/314; H01Q 9/30

(52) U.S. Cl. CPC H01Q 5/35; H01Q 5/314; H01Q 9/30

(57) ABSTRACT

An antenna device includes first and second radiating elements, a frequency adjustment element, and first and second feed circuits. The second radiating element is at a position at which at least one of electric field coupling and magnetic field coupling to the first radiating element can be generated. The frequency adjustment element is connected to the first radiating element or the second radiating element. The first feed circuit is configured to supply a radio frequency signal to the first radiating element. The second feed circuit is configured to supply a radio frequency signal to the second radiating element.

### CROSS REFERENCE TO RELATED APPLICATIONS

This application claims the benefit of priority to Japanese Patent Application No. 2022-041339 filed on Mar. 16, 2022 and is a Continuation Application of PCT Application No. PCT/JP2023/008831 filed on Mar. 8, 2023. The entire contents of each application are hereby incorporated herein by reference.

### BACKGROUND OF THE INVENTION

### 1. Field of the Invention

The present disclosure relates to antenna devices and techniques for communication apparatuses using antenna devices.

### 2. Description of the Related Art

In recent years, communication apparatuses (e.g., smartphones and cellular phones) supporting a plurality of communication systems are required with the progress of technology, and the number of frequency bands that the communication apparatuses support is increasing. To support a plurality of frequency bands, Japanese Unexamined Patent Application Publication No. 2011-071597 discloses a communication apparatus that includes a frequency switching circuit (frequency adjustment element) in an antenna and adjusts frequency bands that the communication apparatus supports.

However, in the case where MIMO (multiple-input and multiple-output) using a plurality of antennas is employed in a communication apparatus, there is the need to provide frequency adjustment elements to match the number of antennas. Accordingly, with the increase in the number of frequency bands that a single communication apparatus supports, the number of antennas increases and the same number of frequency adjustment elements as the number of the antennas are provided. As a result, the cost of the frequency adjustment elements in the single communication apparatus becomes higher.

### SUMMARY OF THE INVENTION

Example embodiments of the present invention provide antenna devices each including a smaller number of frequency adjustment elements than a number of antennas, and communication apparatuses including such antenna devices.

An antenna device according to an example embodiment of the present invention includes a first radiating element, a second radiating element at a position at which at least one of electric field coupling and magnetic field coupling to the first radiating element is capable of being generated, a frequency adjustment element connected to the first radiating element or the second radiating element, a first feed circuit to supply a radio frequency signal to the first radiating element, and a second feed circuit to supply a radio frequency signal to the second radiating element. The first radiating element and the second radiating element are positioned such that the coupling of the first radiating element to the second radiating element is generated at a first point of the first radiating element where a maximum electric field is obtained at a resonant frequency and the coupling of the second radiating element to the first radiating element is generated at a second point of the second radiating element where a maximum electric field is obtained at a resonant frequency.

A communication apparatus according to an example embodiment of the present invention includes an antenna device according to an example embodiment of the present invention and a communication circuit to transmit and receive a signal using the antenna device.

In antenna devices according to example embodiments of the present invention, a second radiating element is located at a position where at least one of electric-field-coupling and magnetic-field-coupling to a first radiating element can be generated and a frequency adjustment element is connected to the first radiating element or the second radiating element. Therefore, the antenna devices according to example embodiments of the present invention each control operating frequency bands with a smaller number of frequency adjustment elements than a number of antennas.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram of an antenna device according to Example Embodiment 1 of the present invention.

FIG. 2 is a schematic diagram of a frequency adjustment element according to Example Embodiment 1 of the present invention.

FIG. 3 is a diagram illustrating reflection characteristics of the antenna device according to Example Embodiment 1. of the present invention

FIGS. 4A and 4B are diagrams illustrating the reflection characteristics of the antenna device according to Example Embodiment 1 of the present invention when an inductance value is changed with a frequency adjustment element included in the antenna device.

FIGS. 5A and 5B are diagrams illustrating the reflection characteristics of the antenna device according to Example Embodiment 1 of the present invention when a capacitance value is changed with the frequency adjustment element included in the antenna device.

FIG. 6 is a schematic diagram of a communication apparatus according to Example Embodiment 1 of the present invention.

FIG. 7 is a schematic diagram of an antenna device according to a modification of Example Embodiment 1 of the present invention.

FIG. 8 is a schematic diagram of an antenna device according to Example Embodiment 2 of the present invention.

FIGS. 9A and 9B are diagrams illustrating reflection characteristics of the antenna device according to Example Embodiment 2 of the present invention including a frequency adjustment element in a second antenna.

FIGS. 10A and 10B are diagrams illustrating the reflection characteristics of the antenna device according to Example Embodiment 2 of the present invention including the frequency adjustment element in a first antenna.

FIG. 11 is a schematic diagram of an antenna device according to Example Embodiment 3 of the present invention.

FIGS. 12A and 12B are diagrams illustrating reflection characteristics of the antenna device according to Example Embodiment 3 of the present invention.

FIG. 13 is a schematic diagram of an antenna device according to a modification of Example Embodiment 3 of the present invention.

FIGS. 14A and 14B are diagrams illustrating reflection characteristics of an antenna device according to a modification of Example Embodiment 3 of the present invention.

### DETAILED DESCRIPTION OF THE EXAMPLE EMBODIMENTS

Example embodiments of the present invention will be described in detail below with reference to drawings. The same reference sign is used to represent the same element or the corresponding element in the drawings, and the description thereof will not be repeated.

### Example Embodiment 1

### Basic Configuration of Antenna Device

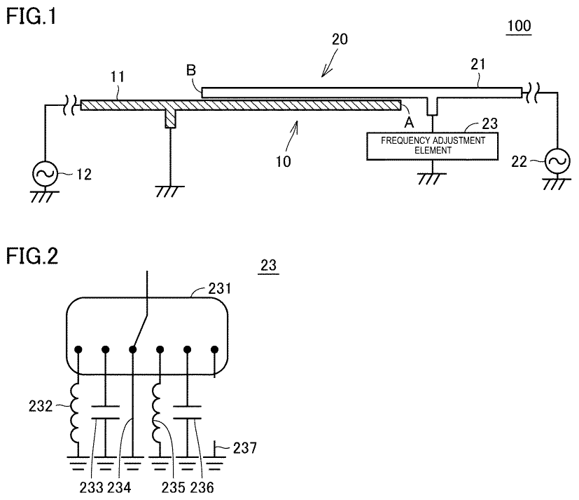

FIG. 1 is a schematic diagram of an antenna device 100 according to Example Embodiment 1 of the present invention. The antenna device 100 includes a first antenna 10 and a second antenna 20. The first antenna 10 includes a first radiating element 11 and a first feed circuit 12. The second antenna 20 includes a second radiating element 21, a second feed circuit 22, and a frequency adjustment element 23. The antenna device 100 is installed in, for example, a mobile terminal, such as a cellular phone, a smartphone, or a tablet computer, or a communication apparatus, such as a personal computer having a communication function.

An antenna device used in a communication apparatus, such as a smartphone, includes a plurality of antennas to satisfy the need to support MIMO or increase support frequency bands like the antenna device 100 including the first antenna 10 and the second antenna 20. However, in an antenna device including a first antenna and a second antenna independently, there has been a need to provide a frequency adjustment element for each of the first antenna and the second antenna to adjust the operating frequency band of each of the first antenna and the second antenna.

In the antenna device 100, the first radiating element 11 included in the first antenna 10 and the second radiating element 21 included in the second antenna 20 are disposed such that the first radiating element 11 and the second radiating element 21 are electric-field-coupled and/or magnetic-field-coupled (hereinafter also referred to simply as coupled) to each other. Therefore, the frequency adjustment element 23 is provided in only the second antenna 20 in the antenna device 100. That is, in the antenna device 100, the coupling between the first antenna 10 and the second antenna 20 can provide a plurality of desired operating frequency bands and at least one of the desired operating frequency bands can be adjusted by the single frequency adjustment element 23. The antenna device 100 may include a frequency adjustment element in only the first antenna 10, instead of in the second antenna 20.

The configuration of the antenna device 100 will be described in more detail. The first antenna 10 and the second antenna 20 are, for example, inverted-F antennas. To enable at least one of the electric field coupling and the magnetic field coupling between the first radiating element 11 and the second radiating element 21, the first antenna 10 and the second antenna 20, which are inverted-F antennas, face each other as illustrated in FIG. 1. Accordingly, the first radiating element 11 and the second radiating element 21 are disposed such that an open end A (radiation end) of the first radiating element 11 and an open end B (radiation end) of the second radiating element 21 are opposite in orientation and the first radiating element 11 and the second radiating element 21 are parallel or substantially parallel to each other.

A position at which the second radiating element 21 is caused to be electric-field-coupled and/or magnetic-field-coupled to the first radiating element 11 is not limited to the position illustrated in FIG. 1. The second radiating element 21 may be disposed with respect to the first radiating element 11 at least such that the open end A (radiation end) of the first radiating element 11 is coupled to the second radiating element 21 at any position of the second radiating element 21 and the open end B (radiation end) of the second radiating element 21 is coupled to the first radiating element 11 at any position of the first radiating element 11.

The open end A of the first radiating element 11 is a point (first point) where the maximum electric field is obtained at a resonant frequency. The open end B of the second radiating element 21 is a point (second point) where the maximum electric field is obtained at a resonant frequency. That is, in the antenna device 100, the second radiating element 21 can be electric-field-coupled and/or magnetic-field-coupled to the first radiating element 11 by disposing the first radiating element 11 and the second radiating element 21 such that the first radiating element 11 is coupled to the second radiating element 21 at the open end A (first point) where the maximum electric field is obtained at the resonant frequency and the second radiating element 21 is coupled to the first radiating element 11 at the open end B (second point) where the maximum electric field is obtained at the resonant frequency.

By disposing the first radiating element 11 and the second radiating element 21 such that the open end A (first point) of the first radiating element 11 is coupled to a point of the second radiating element 21 other than the open end B (second point) and the open end B (second point) of the second radiating element 21 is coupled to a point of the first radiating element 11 other than the open end A (first point), the coupling between the open end A of the first radiating element 11 and the open end B of the second radiating element 21 can be prevented in the antenna device 100.

The first feed circuit 12 supplies a radio frequency signal to the first radiating element 11, and the second feed circuit 22 supplies a radio frequency signal to the second radiating element 21. A frequency adjustment element is not provided for the first radiating element 11, but the frequency adjustment element 23 is provided for the second radiating element 21.

The frequency adjustment element 23 is an element to adjust the operating frequency bands of the first antenna 10 and the second antenna 20 coupled to each other. FIG. 2 is a schematic diagram of the frequency adjustment element 23 according to Example Embodiment 1. As illustrated in FIG. 2, the frequency adjustment element 23 includes multiple elements that are grounded and a switch 231 that is electrically connected to one of the multiple elements. The multiple elements include, for example, a coil 232, a capacitor 233, a short wiring line 234, a coil 235, a capacitor 236, and an open wiring line 237.

The coil 232 has, for example, an inductance value of about 5 nH, and the coil 235 has, for example, an inductance value of about 10 nH. The capacitor 233 has, for example, a capacitance value of about 0.5 pF, and the capacitor 236 has, for example, a capacitance value of about 1 pF. The frequency adjustment element 23 can switch between different inductance values or between different capacitance values to connect the switched value to the second radiating element 21 and can adjust the operating frequency band of the antenna device 100 in accordance with a connected inductance value or a connected capacitance value.

### Characteristics of Antenna Device

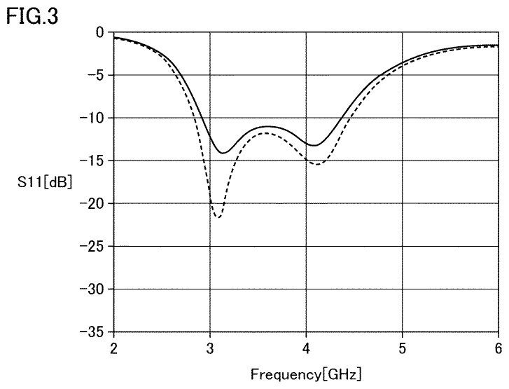

FIG. 3 is a diagram illustrating reflection characteristics of the antenna device 100 according to Example Embodiment 1. In FIG. 3, a horizontal axis represents frequency, a vertical axis represents return loss, a solid line represents the reflection characteristics of the first antenna 10, and a broken line represents the reflection characteristics of the second antenna 20. A return loss is the ratio of power returned from a radiating element to a feed circuit to power output from the feed circuit to the radiating element. Accordingly, frequencies at which the return loss falls lower indicate that power is emitted from the radiating element. By the coupling between the first antenna 10 and the second antenna 20, the antenna device 100 has two operating frequency bands, that is, for example, a frequency band having the center frequency at approximately 3.1 GHz and a frequency band having the center frequency at approximately 4.1 GHz, as illustrated in FIG. 3. Here, the frequency adjustment element 23 is in an open state in which it is not connected to the ground, that is, is connected to open wiring line 237 in FIG. 2.

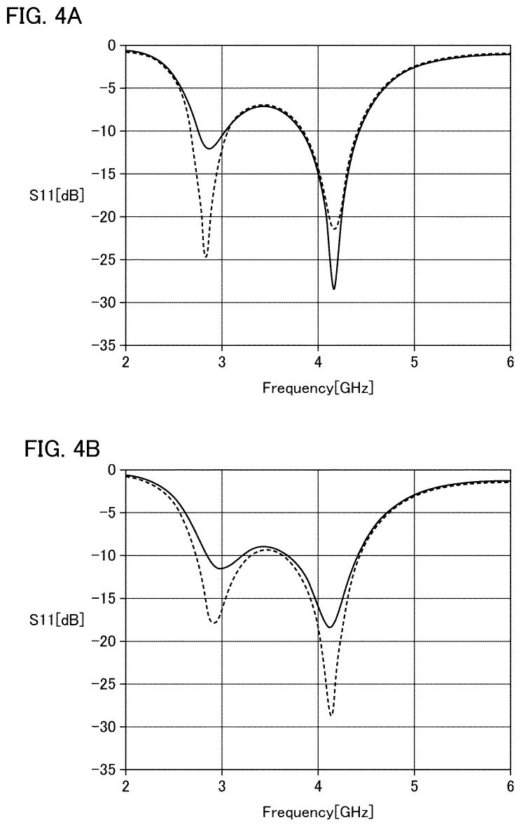

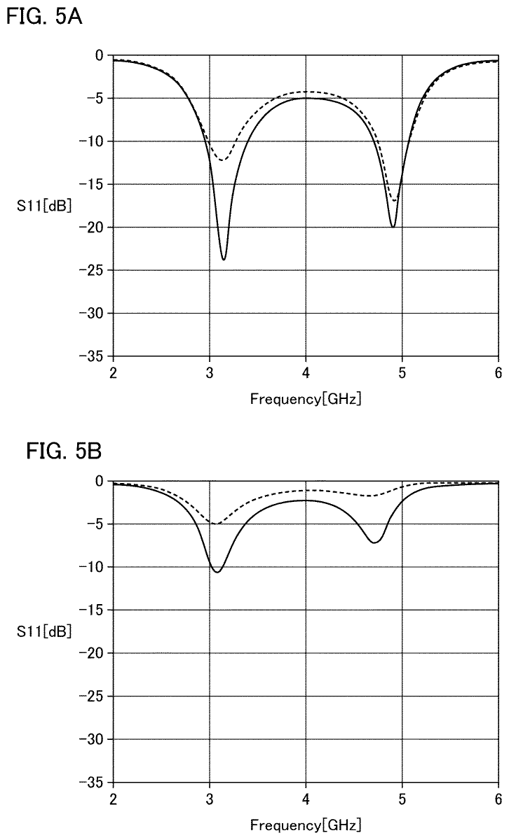

The antenna device 100 can collectively adjust the two operating frequency bands with the frequency adjustment element 23. FIGS. 4A and 4B are diagrams illustrating the reflection characteristics of the antenna device 100 according to Example Embodiment 1 when an inductance value is changed with the frequency adjustment element 23 included in the antenna device 100. FIGS. 5A and 5B are diagrams illustrating the reflection characteristics of the antenna device 100 according to Example Embodiment 1 when a capacitance value is changed with the frequency adjustment element 23 included in the antenna device 100. In FIGS. 4 and 5, a horizontal axis represents frequency, a vertical axis represents return loss, a solid line represents the reflection characteristics of the first antenna 10, and a broken line represents the reflection characteristics of the second antenna 20.

FIG. 4A illustrates reflection characteristics when the switch 231 is connected to the coil 232 having the inductance value of, for example, about 5 nH in the frequency adjustment element 23. In the reflection characteristics illustrated in FIG. 4A, for example, the frequency band having the center frequency at approximately 3.1 GHZ illustrated in FIG. 3 is changed to a frequency band having the center frequency at approximately 2.8 GHz and the frequency band having the center frequency at approximately 4.1 GHz illustrated in FIG. 3 is changed to a frequency band having the center frequency at approximately 4.2 GHz.

FIG. 4B illustrates reflection characteristics when the switch 231 is connected to the coil 235 having the inductance value of, for example, about 10 nH in the frequency adjustment element 23. In the reflection characteristics illustrated in FIG. 4B, for example, the frequency band having the center frequency at approximately 3.1 GHZ illustrated in FIG. 3 is changed to a frequency band having the center frequency at approximately 2.9 GHz and the frequency band having the center frequency at approximately 4.1 GHz illustrated in FIG. 3 is changed to a frequency band having the center frequency at approximately 4.2 GHz. In the reflection characteristics illustrated in FIG. 4B, the return loss of the second antenna 20 decreases in the frequency band having the center frequency at approximately 4.2 GHz as compared with the reflection characteristics illustrated in FIG. 4A and power that can be emitted from the second antenna 20 increases.

FIG. 5A illustrates reflection characteristics when the switch 231 is connected to the capacitor 233 having the capacitance value of, for example, about 0.5 pF in the frequency adjustment element 23. In the reflection characteristics illustrated in FIG. 5A, for example, the frequency band having the center frequency at approximately 3.1 GHZ illustrated in FIG. 3 is changed to a frequency band having the center frequency at approximately 3.2 GHz and the frequency band having the center frequency at approximately 4.1 GHz illustrated in FIG. 3 is changed to a frequency band having the center frequency at approximately 4.9 GHz.

FIG. 5B illustrates reflection characteristics when the switch 231 is connected to the capacitor 236 having the capacitance value of, for example, about 1 pF in the frequency adjustment element 23. In the reflection characteristics illustrated in FIG. 5B, for example, the frequency band having the center frequency at approximately 3.1 GHz illustrated in FIG. 3 is not changed and the frequency band having the center frequency at approximately 4.1 GHz illustrated in FIG. 3 is changed to a frequency band having the center frequency at approximately 4.7 GHZ. In the reflection characteristics illustrated in FIG. 5B, the return loss of the second antenna 20 increases in the frequency band having the center frequency at approximately 4.7 GHz as compared with the reflection characteristics illustrated in FIG. 5A.

In the antenna device 100, the single frequency adjustment element 23 for the two antennas (the first antenna 10 and the second antenna 20) can collectively control the center frequencies of the two frequency bands as represented by the reflection characteristics illustrated in FIGS. 4 and 5. The switch 231 switches between the respective individual elements, that is, between the coils 232 and 235 or between the capacitors 233 and 236, to perform frequency adjustment in the frequency adjustment element 23, but may switch between elements that are the combinations of a coil and a capacitor to perform frequency adjustment or may use a variable capacitance element and a variable inductance element instead of the switch and these passive elements.

### Communication Apparatus Using Antenna Device

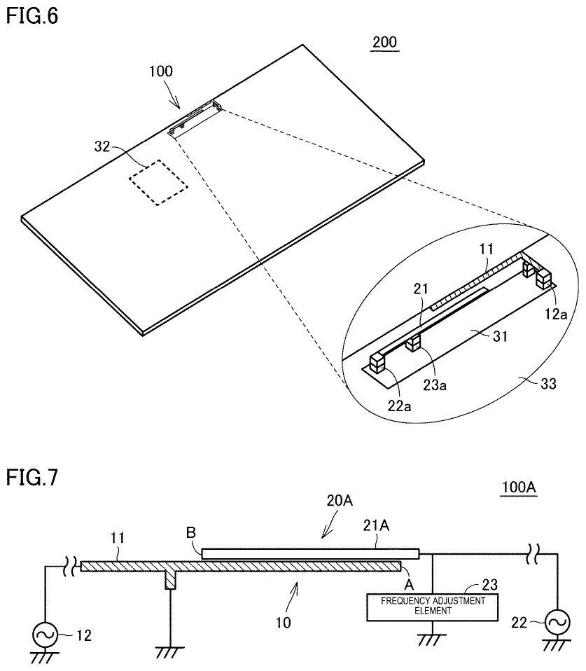

FIG. 6 is a schematic diagram of a communication apparatus according to Example Embodiment 1. The communication apparatus illustrated in FIG. 6 is a portable terminal 200 that can perform communication in a plurality of frequency bands (e.g., n78 (about 3.3 GHZ to about 3.8 GHZ) and n79 (about 4.4 GHz to about 5.0 GHZ)). Accordingly, the antenna device 100 including the first antenna 10 and the second antenna 20 is provided in the portable terminal 200. The portable terminal 200 is, for example, a cellular phone, a smartphone, or a tablet computer.

In the antenna device 100, the first radiating element 11 and the second radiating element 21 face each other on a substrate 31 such that the second radiating element 21 is electric-field-coupled and/or magnetic-field-coupled to the first radiating element 11. The first radiating element 11 includes a connection terminal 12a to connect to the first feed circuit 12 illustrated in FIG. 1. The second radiating element 21 includes a connection terminal 22a to connect to the second feed circuit 22 illustrated in FIG. 1 and a connection terminal 23a to connect to the frequency adjustment element 23 illustrated in FIG. 1. In FIG. 6, the first feed circuit 12, the second feed circuit 22, and the frequency adjustment element 23 are not illustrated, because those are provided on the back side of the surface of the substrate 31 on which the first radiating element 11 and the second radiating element 21 are provided. The portable terminal 200 further includes an RFIC 32 (semiconductor IC) connected to the first feed circuit 12 and the second feed circuit 22 in the antenna device 100. A region 33 other than a region where the substrate 31 is provided includes a conductor connected to a ground potential.

### Modification of Antenna Device

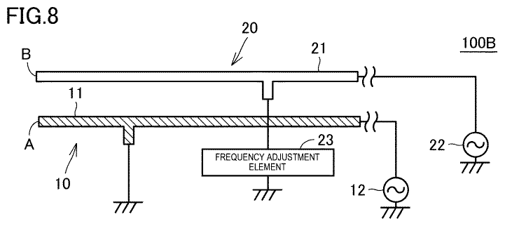

FIG. 7 is a schematic diagram of an antenna device 100A according to a modification of Example Embodiment 1 of the present invention. The antenna device 100A includes the first antenna 10 and a second antenna 20A. The first antenna 10 includes the first radiating element 11 and the first feed circuit 12. The second antenna 20A includes a second radiating element 21A, the second feed circuit 22, and the frequency adjustment element 23. The second radiating element 21A differs from the second radiating element 21 illustrated in FIG. 1 in that the second radiating element 21A is not grounded via the frequency adjustment element 23, and the frequency adjustment element 23 is provided on the feed circuit side. Accordingly, the second antenna 20A is, for example, a monopole antenna. The first antenna 10 does not necessarily have to be an inverted-F antenna and may be a monopole antenna, for example.

To allow the first radiating element 11 and the second radiating element 21A to be electric-field-coupled and/or magnetic-field-coupled to each other, the first antenna 10 that is an inverted-F antenna and the second antenna 20A that is a monopole antenna face each other as illustrated in FIG. 7. Accordingly, the first radiating element 11 and the second radiating element 21A are disposed such that the open end A of the first radiating element 11 and the open end B of the second radiating element 21A are opposite in orientation and the first radiating element 11 and the second radiating element 21A are parallel or substantially parallel to each other.

The antenna device 100A can collectively adjust two operating frequency bands with the frequency adjustment element 23 included in the second antenna 20A. In the antenna device 100A illustrated in FIG. 7, for example, the frequency adjustment element 23 is provided in the second antenna 20A that is a monopole antenna, but may be provided in the first antenna 10 that is an inverted-F antenna. In the case where the frequency adjustment element 23 is provided in the second antenna 20A that is a monopole antenna, the frequency adjustment element 23 can be connected in series with the second radiating element 21A. However, since an element included in the frequency adjustment element 23 affects the characteristics of the second antenna 20A in the case where the frequency adjustment element 23 is connected in series with the second radiating element 21A, the frequency adjustment element 23 is preferably connected in shunt with the feed circuit side as illustrated in FIG. 7.

As described above, the antenna devices 100 and 100A according to Example Embodiment 1 include the first radiating element 11, the second radiating elements 21 and 21A disposed at a position where at least one of electric-field-coupling and magnetic-field-coupling to the first radiating element 11 can be generated, the frequency adjustment element 23 that is connected to the first radiating element 11 or the second radiating elements 21 and 21A, the first feed circuit 12 to supply a radio frequency signal to the first radiating element 11, and the second feed circuit 22 to supply a radio frequency signal to the second radiating elements 21 and 21A.

Accordingly, in the antenna devices 100 and 100A according to Example Embodiment 1, the second radiating elements 21 and 21A are disposed at a position where at least one of electric-field-coupling and magnetic-field-coupling to the first radiating element 11 can be generated and the frequency adjustment element 23 is connected to the first radiating element 11 or the second radiating elements 21 and 21A. Therefore, operating frequency bands can be controlled with a smaller number of frequency adjustment elements than the number of antennas.

Preferably, the first radiating element 11 and the second radiating elements 21 and 21A are disposed such that the first radiating element 11 is electric-field-coupled to the second radiating elements 21 and 21A at the open end A (first point) where the maximum electric field is obtained at a resonant frequency and the second radiating elements 21 and 21A are electric-field-coupled to the first radiating element 11 at the open end B (second point) where the maximum electric field is obtained at a resonant frequency. In this case, the second radiating elements 21 and 21A are electric-field-coupled and/or magnetic-field-coupled to the first radiating element 11.

Preferably, the first radiating element 11 and the second radiating elements 21 and 21A are disposed such that the open end A (first point) of the first radiating element 11 is electric-field-coupled to a point of the second radiating elements 21 and 21A other than the open end B (second point) and the open end B (second point) of the second radiating elements 21 and 21A is electric-field-coupled to a point of the first radiating element 11 other than the open end A (first point). In this case, the second radiating elements 21 and 21A are electric-field-coupled and/or magnetic-field-coupled to the first radiating element 11.

Specifically, preferably, the first radiating element 11 and the second radiating elements 21 and 21A are disposed such that the open end A of the first radiating element 11 and the open end B of the second radiating elements 21 and 21A are opposite in orientation. Furthermore, preferably, the first radiating element 11 and the second radiating elements 21 and 21A are disposed such that the first radiating element 11 is parallel or substantially parallel to the second radiating elements 21 and 21A.

The portable terminal 200 (communication apparatus) includes the antenna device 100 and 100A and the RFIC 32 (semiconductor IC) connected to the first feed circuit 12 and the second feed circuit 22 in the antenna devices 100 and 100A. The portable terminal 200 (communication apparatus) can therefore perform communication in a wider frequency band by adjusting a plurality of operating frequency bands.

### Example Embodiment 2

In Example Embodiment 1, for example, the antenna device 100 has been described in which the first antenna 10 and the second antenna 20 that are inverted-F antennas are disposed to face each other as illustrated in FIG. 1. In Example Embodiment 2 of the present invention, an antenna device will be described in which the first antenna and the second antenna face in the same direction.

### Basic Configuration of Antenna Device

FIG. 8 is a schematic diagram of an antenna device 100B according to Example Embodiment 2. The antenna device 100B includes the first antenna 10 and the second antenna 20. The first antenna 10 includes the first radiating element 11 and the first feed circuit 12. The second antenna 20 includes the second radiating element 21, the second feed circuit 22, and the frequency adjustment element 23.

The configuration of the antenna device 100B will be described in more detail. The first antenna 10 and the second antenna 20 are, for example, inverted-F antennas. To allow the first radiating element 11 and the second radiating element 21 to be electric-field-coupled and/or magnetic-field-coupled to each other, the first antenna 10 and the second antenna 20 that are inverted-F antennas face in the same direction as illustrated in FIG. 8. Accordingly, the first radiating element 11 and the second radiating element 21 are disposed such that the open end A of the first radiating element 11 and the open end B of the second radiating element 21 have the same orientation and the first radiating element 11 and the second radiating element 21 are parallel or substantially parallel to each other.

### Characteristics of Antenna Device

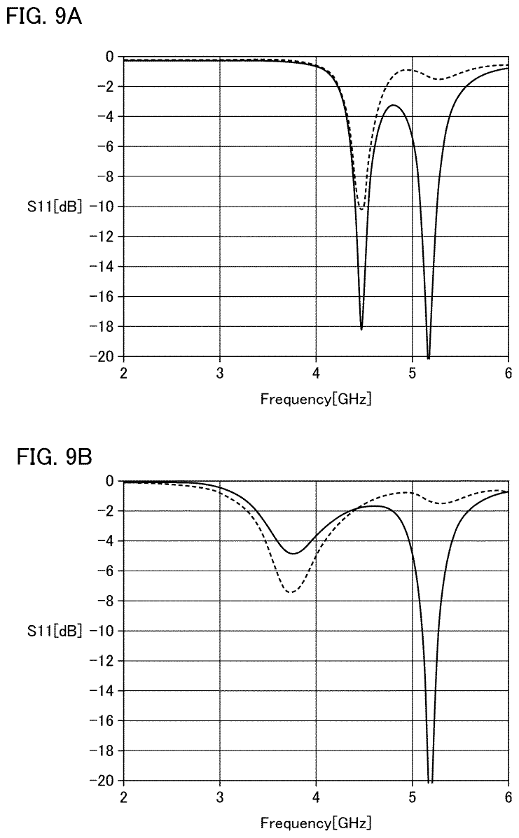

FIGS. 9A and 9B are diagrams illustrating reflection characteristics of the antenna device 100B according to Example Embodiment 2 including the frequency adjustment element 23 in the second antenna 20. In FIGS. 9A and 9B, a horizontal axis represents frequency, a vertical axis represents return loss, a solid line represents the reflection characteristics of the first antenna 10, and a broken line represents the reflection characteristics of the second antenna 20.

FIG. 9A illustrates reflection characteristics when the switch 231 is connected to the short wiring line 234 illustrated in FIG. 2 in the frequency adjustment element 23. That is, an inductance value and a capacitance value that are connected to the second radiating element 21 are, for example, about 0 nH and about 0 pF, respectively. In the reflection characteristics illustrated in FIG. 9A, there are two operating frequency bands, that is, for example, a frequency band having the center frequency at approximately 4.5 GHz and a frequency band having the center frequency at approximately 5.2 GHz.

FIG. 9B illustrates reflection characteristics when the switch 231 is connected to the coil 232 having the inductance value of, for example, about 5 nH illustrated in FIG. 2 in the frequency adjustment element 23. In the reflection characteristics illustrated in FIG. 9B, for example, the frequency band having the center frequency at approximately 4.5 GHz illustrated in FIG. 9A is changed to a frequency band having the center frequency at approximately 3.7 GHZ and the frequency band having the center frequency at approximately 5.2 GHz is substantially not changed. By providing the frequency adjustment element 23 in the second antenna 20, the antenna device 100B can mainly adjust the frequency band having the center frequency at approximately 4.5 GHZ.

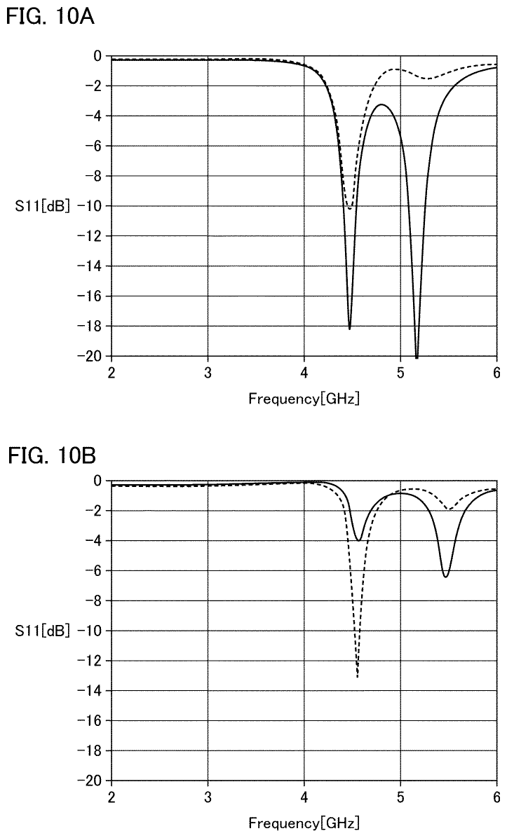

Although not illustrated, the case will be described where a frequency adjustment element is not provided in the second antenna 20 but in the first antenna 10 in the antenna device 100B. FIGS. 10A and 10B are diagrams illustrating the reflection characteristics of the antenna device 100B according to Example Embodiment 2 including a frequency adjustment element in the first antenna 10. In FIGS. 10A and 10B, a horizontal axis represents frequency, a vertical axis represents return loss, a solid line represents the reflection characteristics of the first antenna 10, and a broken line represents the reflection characteristics of the second antenna 20.

FIG. 10A illustrates reflection characteristics when the switch is connected to the short wiring line in the frequency adjustment element. That is, an inductance value and a capacitance value that are connected to the first radiating element 11 are, for example, about 0 nH and about 0 pF, respectively. In the reflection characteristics illustrated in FIG. 10A, there are two operating frequency bands, that is, for example, a frequency band having the center frequency at approximately 4.5 GHZ and a frequency band having the center frequency at approximately 5.2 GHz. The reflection characteristics illustrated in FIG. 10A are the same or substantially the same as those illustrated in FIG. 9A.

FIG. 10B illustrates reflection characteristics when the switch is connected to the capacitor having the capacitance value of, for example, about 2 pF in the frequency adjustment element. In the reflection characteristics illustrated in FIG. 10B, for example, the frequency band having the center frequency at approximately 4.5 GHz illustrated in FIG. 10A is substantially not changed and the frequency band having the center frequency at approximately 5.2 GHz is changed to a frequency band having the center frequency at approximately 5.5 GHZ. By providing a frequency adjustment element in the first antenna 10, the antenna device 100B can mainly adjust the frequency band having the center frequency at approximately 5.2 GHz.

The antenna device 100B has two operating frequency bands by disposing the first antenna 10 and the second antenna 20 such that they face in the same direction and are coupled to each other, and any one of the two operating frequency bands can be mainly adjusted depending on which of the antennas includes a frequency adjustment element.

### Example Embodiment 3

In the modification of Example Embodiment 1, the antenna device 100A has been described in which the first antenna 10 that is an inverted-F antenna and the second antenna 20A that is a monopole antenna are disposed to face each other as illustrated in FIG. 7. In Example Embodiment 3 of the present invention, for example, an antenna device will be described in which not only an inverted-F antenna and a monopole antenna but also a loop antenna is used.

### Basic Configuration of Antenna Device

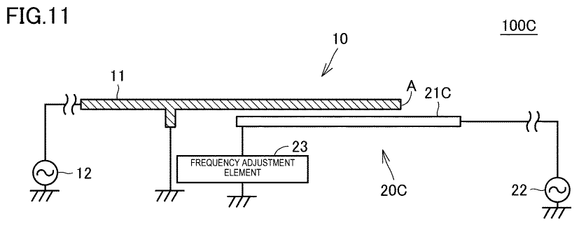

FIG. 11 is a schematic diagram of an antenna device 100C according to Example Embodiment 3. The antenna device 100C includes the first antenna 10 and a second antenna 20C. The first antenna 10 includes the first radiating element 11 and the first feed circuit 12. The second antenna 20C includes a second radiating element 21C, the second feed circuit 22, and the frequency adjustment element 23.

The configuration of the antenna device 100C will be described in more detail. For example, the first antenna 10 is an inverted-F antenna, and the second antenna 20C is a loop antenna. In the second antenna 20C that is a loop antenna, the second feed circuit 22 is connected to one end of the second radiating element 21C and the frequency adjustment element 23 is connected to the other end of the second radiating element 21C. The frequency adjustment element 23 does not necessarily have to be provided in the second antenna 20C and may be provided in the first antenna 10.

To allow the first radiating element 11 and the second radiating element 21C to be electric-field-coupled and/or magnetic-field-coupled to each other, the first antenna 10 and the second antenna 20C are disposed such that the orientation of the first antenna 10 that is an inverted-F antenna viewed from the first feed circuit 12 and the orientation of the second antenna 20C that is a loop antenna viewed from the second feed circuit 22 face each other as illustrated in FIG. 11. Accordingly, the first radiating element 11 and the second radiating element 21C are disposed such that the open end A of the first radiating element 11 and the side of the second radiating element 21C to which the frequency adjustment element 23 is connected are opposite in orientation and there is a portion where the first radiating element 11 and the second radiating element 21C are parallel or substantially parallel to each other.

In the first antenna 10 that is an inverted-F antenna, the open end A of the first radiating element 11 is a point (first point) where the maximum electric field is obtained at a resonant frequency. However, in the second antenna 20C, which is a loop antenna, the maximum electric field is obtained at a resonant frequency in the center portion (second point) of the second radiating element 21C. Accordingly, to allow the second radiating element 21C to be electric-field-coupled and/or magnetic-field-coupled to the first radiating element 11, preferably, the open end A (the first point) of the first radiating element 11 is coupled to a point of the second radiating element 21C other than the center portion (second point) and the center portion (second point) of the second radiating element 21C is coupled to a point of the first radiating element 11 other than the open end A (first point) in the antenna device 100C.

### Characteristics of Antenna Device

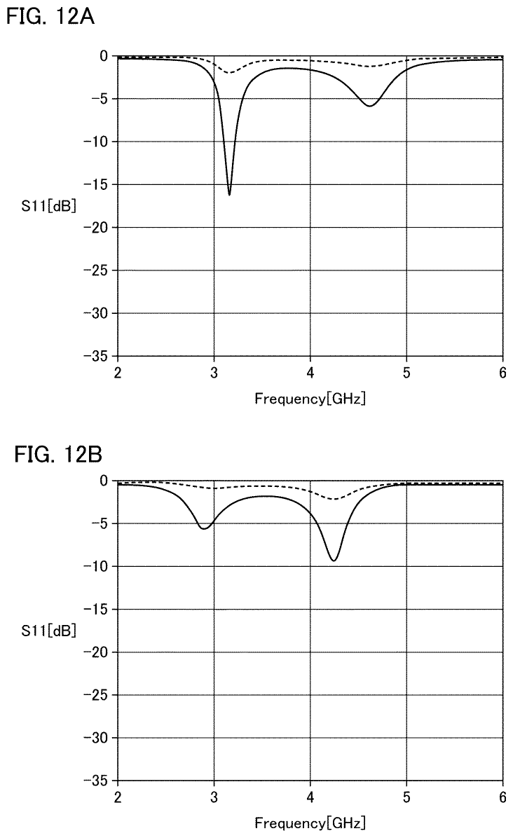

FIGS. 12A and 12B are diagrams illustrating reflection characteristics of the antenna device 100C according to Example Embodiment 3. In FIGS. 12A and 12B, a horizontal axis represents frequency, a vertical axis represents return loss, a solid line represents the reflection characteristics of the first antenna 10, and a broken line represents the reflection characteristics of the second antenna 20C. The antenna device 100C has two operating frequency bands by the coupling between the first antenna 10 and the second antenna 20C and can collectively adjust the two operating frequency bands with the frequency adjustment element 23 included in the second antenna 20C.

FIG. 12A illustrates reflection characteristics when the switch 231 is connected to the coil 232 having the inductance value of, for example, about 5 nH illustrated in FIG. 2 in the frequency adjustment element 23. In the reflection characteristics illustrated in FIG. 12A, there are two operating frequency bands, that is, for example, a frequency band having the center frequency at approximately 3.2 GHZ and a frequency band having the center frequency at approximately 4.7 GHZ.

FIG. 12B illustrates reflection characteristics when the switch 231 is connected to the coil 235 having the inductance value of, for example, about 10 nH illustrated in FIG. 2 in the frequency adjustment element 23. In the reflection characteristics illustrated in FIG. 12B, for example, the frequency band having the center frequency at approximately 3.2 GHz illustrated in FIG. 12A is changed to a frequency band having the center frequency at approximately 2.9 GHZ and the frequency band having the center frequency at approximately 4.7 GHZ illustrated in FIG. 12A is changed to a frequency band having the center frequency at approximately 4.3 GHZ.

### Modification of Antenna Device

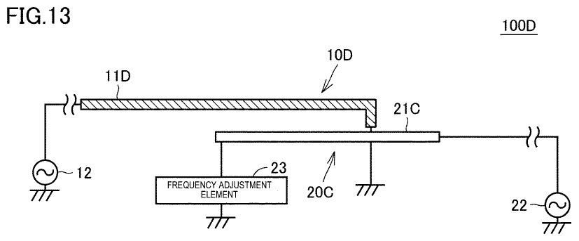

FIG. 13 is a schematic diagram of an antenna device 100D according to a modification of Example Embodiment 3. The antenna device 100D includes a first antenna 10D and the second antenna 20C. The first antenna 10D includes a first radiating element 11D and the first feed circuit 12. The second antenna 20C includes the second radiating element 21C, the second feed circuit 22, and the frequency adjustment element 23.

The configuration of the antenna device 100D will be described in more detail. The first antenna 10D and the second antenna 20C are loop antennas, for example. In the first antenna 10D that is a loop antenna, the first feed circuit 12 is connected to one end of the first radiating element 11D and the other end of the first radiating element 11D is grounded. In the second antenna 20C that is a loop antenna, the second feed circuit 22 is connected to one end of the second radiating element 21C and the frequency adjustment element 23 is connected to the other end of the second radiating element 21C. The frequency adjustment element 23 does not necessarily have to be provided in the second antenna 20C and may be provided in the first antenna 10D.

To allow the first radiating element 11D and the second radiating element 21C to be electric-field-coupled and/or magnetic-field-coupled to each other, the first antenna 10D and the second antenna 20C are disposed such that the orientation of the first antenna 10D that is a loop antenna viewed from the first feed circuit 12 and the orientation of the second antenna 20C that is a loop antenna viewed from the second feed circuit 22 face each other as illustrated in FIG. 13. Accordingly, the first radiating element 11D and the second radiating element 21C are disposed such that the grounded side of the first radiating element 11D and the side of the second radiating element 21C to which the frequency adjustment element 23 is connected are opposite in orientation and there is a portion where the first radiating element 11D and the second radiating element 21C are parallel or substantially parallel to each other.

In the first antenna 10D that is a loop antenna, the maximum electric field is obtained at a resonant frequency in the center portion (first point) of the first radiating element 11D. In the second antenna 20C that is a loop antenna, the maximum electric field is similarly obtained at a resonant frequency in the center portion (second point) of the second radiating element 21C. Accordingly, to allow the second radiating element 21C to be electric-field-coupled and/or magnetic-field-coupled to the first radiating element 11D, preferably, the center portion (first point) of the first radiating element 11D is connected to a point of the second radiating element 21C other than the center portion (second point) and the center portion (second point) of the second radiating element 21C is connected to a point of the first radiating element 11D other than the center portion (first point) in the antenna device 100D.

### Characteristics of Antenna Device

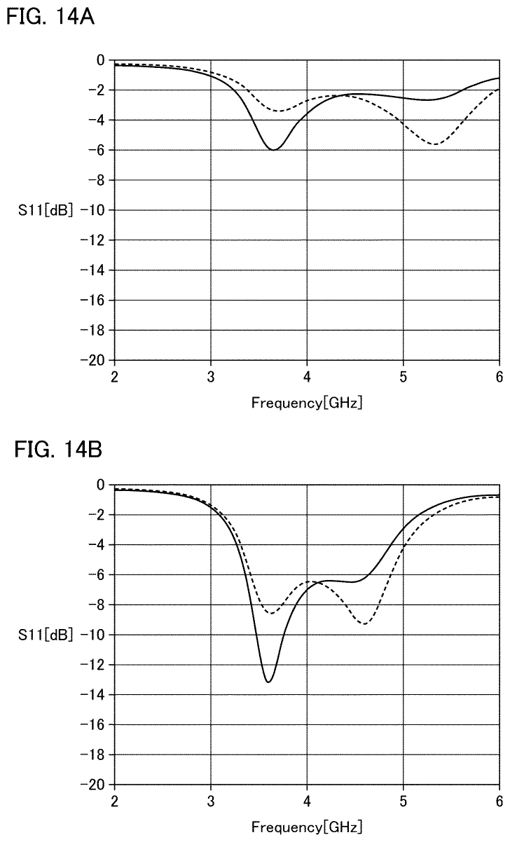

FIGS. 14A and 14B are diagrams illustrating reflection characteristics of the antenna device 100D according to the modification of Example Embodiment 3. In FIGS. 14A and 14B, a horizontal axis represents frequency, a vertical axis represents return loss, a solid line represents the reflection characteristics of the first antenna 10D, and a broken line represents the reflection characteristics of the second antenna 20C. The antenna device 100D has two operating frequency bands by the coupling between the first antenna 10D and the second antenna 20C and can adjust the two operating frequency bands with the frequency adjustment element 23 included in the second antenna 20C.

FIG. 14A illustrates reflection characteristics when the switch 231 is connected to the coil 232 having the inductance value of, for example, about 5 nH illustrated in FIG. 2 in the frequency adjustment element 23. In the reflection characteristics illustrated in FIG. 14A, there are two operating frequency bands, that is, for example, a frequency band having the center frequency at approximately 3.7 GHZ and a frequency band having the center frequency at approximately 5.3 GHZ. A coil (e.g., a coil having the inductance value of about 5 nH) to adjust an inductance value may be connected to the first radiating element 11D.

FIG. 14B illustrates reflection characteristics when the switch 231 is connected to the coil 235 having the inductance value of, for example, about 10 nH illustrated in FIG. 2 in the frequency adjustment element 23. In the reflection characteristics illustrated in FIG. 14B, for example, the frequency band having the center frequency at approximately 3.7 GHZ illustrated in FIG. 14A is not substantially changed and the frequency band having the center frequency at approximately 5.3 GHZ is changed to a frequency band having the center frequency at approximately 4.6 GHz. A coil (e.g., a coil having the inductance value of 5 nH) to adjust an inductance value may be connected to the first radiating element 11D.

The antenna device 100D has two operating frequency bands by the coupling between the first antenna 10D and the second antenna 20C that are loop antennas and can mainly control any one of the two operating frequency bands with the frequency adjustment element 23.

As described above, for example, the first antenna including the first radiating element and the first feed circuit may be any one of a monopole antenna, an inverted-F antenna, and a loop antenna and the second antenna including the second radiating element and the second feed circuit may be any one of a monopole antenna, an inverted-F antenna, and a loop antenna. The frequency adjustment element may be connected to the first radiating element or the second radiating element.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device comprising:
a first radiating element;
a second radiating element at a position at which at least one of electric field coupling and magnetic field coupling to the first radiating element is capable of being generated;
a frequency adjustment element connected to the first radiating element or the second radiating element;
a first feed circuit to supply a radio frequency signal to the first radiating element; and
a second feed circuit to supply a radio frequency signal to the second radiating element; wherein
the first radiating element and the second radiating element are positioned such that the at least one of the electric field coupling and magnetic field coupling of the first radiating element to the second radiating element is generated at a first point of the first radiating element where a maximum electric field is obtained at a resonant frequency and the at least one of the electric field coupling and magnetic field coupling of the second radiating element to the first radiating element is generated at a second point of the second radiating element where a maximum electric field is obtained at a resonant frequency.

2. The antenna device according to claim 1, wherein the first radiating element and the second radiating element are positioned such that the at least one of the electric field coupling and magnetic field coupling of the first point of the first radiating element to a point of the second radiating element other than the second point is generated and the at least one of the electric field coupling and magnetic field coupling of the second point of the second radiating element to a point of the first radiating element other than the first point is generated.

3. The antenna device according to claim 1, wherein
the first radiating element and the first feed circuit define a first antenna;
the first antenna is any one of a monopole antenna, an inverted-F antenna, and a loop antenna;
the second radiating element and the second feed circuit define a second antenna; and
the second antenna is any one of a monopole antenna, an inverted-F antenna, or a loop antenna.

4. The antenna device according to claim 3, wherein, when one of the first antenna and the second antenna is the monopole antenna and another one of the first antenna and the second antenna is the inverted-F antenna, the first radiating element and the second radiating element are positioned such that an open end of the first radiating element and an open end of the second radiating element are opposite in orientation.

5. The antenna device according to claim 1, wherein the first radiating element and the second radiating element are parallel or substantially parallel to each other.

6. The antenna device according to claim 3, wherein both of the first antenna and the second antenna are the inverted-F antenna.

7. The antenna device according to claim 3, wherein both of the first antenna and the second antenna are the loop antenna.

8. The antenna device according to claim 1, wherein the frequency adjustment element includes a plurality of elements that are grounded and a switch electrically connected to one of the plurality of elements.

9. The antenna device according to claim 8, wherein the plurality of elements include at least one coil, at least one capacitor, and at least one wiring line.

10. A communication apparatus comprising:
the antenna device according to claim 1; and
a semiconductor IC connected to the first feed circuit and the second feed circuit included in the antenna device.

11. The communication apparatus according to claim 10, wherein the first radiating element and the second radiating element are positioned such that the at least one of the electric field coupling and magnetic field coupling of the first point of the first radiating element to a point of the second radiating element other than the second point is generated and the at least one of the electric field coupling and magnetic field coupling of the second point of the second radiating element to a point of the first radiating element other than the first point is generated.

12. The communication apparatus according to claim 10, wherein
the first radiating element and the first feed circuit define a first antenna;
the first antenna is any one of a monopole antenna, an inverted-F antenna, or a loop antenna;
the second radiating element and the second feed circuit define a second antenna; and
the second antenna is any one of a monopole antenna, an inverted-F antenna, or a loop antenna.

13. The communication apparatus according to claim 12, wherein, when one of the first antenna and the second antenna is the monopole antenna and another one of the first antenna and the second antenna is the inverted-F antenna, the first radiating element and the second radiating element are positioned such that an open end of the first radiating element and an open end of the second radiating element are opposite in orientation.

14. The communication apparatus according to claim 10, wherein the first radiating element and the second radiating element are parallel or substantially parallel to each other.

15. The communication apparatus according to claim 12, wherein both of the first antenna and the second antenna are the inverted-F antenna.

16. The communication apparatus according to claim 12, wherein both of the first antenna and the second antenna are the loop antenna.

17. The communication apparatus according to claim 10, wherein the frequency adjustment element includes a plurality of elements that are grounded and a switch electrically connected to one of the plurality of elements.

18. The communication apparatus according to claim 17, wherein the plurality of elements include at least one coil, at least one capacitor, and at least one wiring line.
